(19) United States
(12) Patent Application Publication
(10) Pub. No.: US 2015/0228028 A1
(43) Pub. Date: Aug. 13, 2015

(54) SYSTEM AND METHOD FOR HOUSEHOLD GOODS INVENTORY

(71) Applicant: Morris Fritz Friedman, Encino, CA (US)

(72) Inventor: Morris Fritz Friedman, Encino, CA (US)

(21) Appl. No.: 14/616,416

(22) Filed: Feb. 6, 2015

Related U.S. Application Data
(60) Provisional application No. 61/938,644, filed on Feb. 11, 2014.
(60) Provisional application No. 61/939,651, filed on Feb. 13, 2014.

(51) Int. Cl. G06Q 40/08; G06K 9/00; G06Q 10/08; H04L 29/08

(52) U.S. Cl. CPC G06Q 40/08; G06Q 10/087; H04L 67/1095; G06K 9/00671; G06K 9/00771

(57) ABSTRACT

A system and method for automated preparation of a goods inventory of a residence or business.

### CROSS-REFERENCE TO RELATED PATENT APPLICATIONS

This application claims priority to U.S. provisional patent application Ser. No. 61/938,644, filed Feb. 11, 2014; and claims priority to U.S. provisional patent application Ser. No. 61/939,651, filed Feb. 13, 2014, the entire contents of which applications are incorporated herein by reference.

### BACKGROUND

When crime or catastrophe strikes, homeowners rely on their insurance coverage to ensure that they are left ‘whole,’ by being compensated for their losses. Yet because policyholders are constant consumers, new items may often be added to their homes, while other items may be removed. Rarely do policyholders have the time, inclination and/or foresight to update their treasure trove of ‘proofs’ of ownership during the ongoing cavalcade of life. Thus, not only do homeowners have difficulty proving losses, but they often find themselves underinsured or over insured for the value of their actual household assets, even if their inventory was comprehensive and accurate at the time of its compilation.

Various household inventory log products of varying degree of technological sophistication exist, but all share the limiting reality of requiring updates to be proactively triggered. Nothing to applicant's knowledge provides an easy, detailed, accurate, primarily reactive system, one for which once initially established, updates could be virtually automatic and timely, that would be acceptable to consumers or whose use could be mandated by insurers.

Insurance companies face their own challenges. Once a homeowner's policy has been purchased and in force, they stagnate; there seems to be no practical way for the company to make the policy evolve with changing situations and to grow as a source of revenue. Also, driven not by greed, but often by a need to weed out fraud on the part of their policyholders, insurers have to establish reasonable, acceptable and implementable proof of loss. Traditionally this has been accomplished by requiring homeowners to produce various forms of documentation, either preserved purchase receipts and/or photographs and/or written inventories generated by the insured himself.

Another industry standard approach may be to actuarially calculate average losses and set premium rates accordingly. While perhaps unavoidable when underwriting death benefits and health coverage rates, this could prove highly unfair to individual homeowner policy holders. Indeed, this type of disparity may have contributed to the recent development of “good driver” on-board car monitoring technologies and the concomitant premium discounts in individual auto insurance rates. The reinvigorated competition in the car insurance market that resulted has proven beneficial to drivers as well as to the industry.

Under the current paradigm, when the need for a claim emerges, the proofs may have been destroyed, and/or there is often a delay needed to compile the proofs. This occurs at exactly the moment when most policyholders can ill afford the wait for an insurance settlement and have perhaps even greater concerns on their minds.

This somewhat ad hoc and often inaccurate, if not fictional, approach to loss verification has virtually guaranteed that any claim is, at its core, contentious and unsatisfying on many levels. Accordingly there is a need for an objective, reliable and easily implemented system that would provide acceptable and accessible documentation that is up-to-date, may communicate proactively to the insurance carrier and is easy and as foolproof as possible for the insured.

### BRIEF DESCRIPTION OF THE DRAWINGS

Features and advantages of the disclosure will readily be appreciated by persons skilled in the art from the following detailed description when read in conjunction with the drawing wherein:

FIG. 1 is a schematic block diagram of a system for automated compilation of a household item inventory.

FIG. 2 is a diagrammatic view of a household area with a mounted camera for photographing items and transmitting an inventory to a remote location, such as the homeowner's computer or mobile device as well as an insurance company email address or website.

FIG. 3 is a diagrammatic view of a household area with a ceiling mounted camera for photographing household items, with the capability to extend or drop down from the ceiling and rotate 360 degrees to produce images of hidden or partially obscured items.

FIG. 4 is a diagrammatic view of a household area with a ceiling mounted fish eye or panoramic camera for photographing household items, with the capability to extend or drop down from the ceiling and produce a single or segmented 360 degree, panoramic or hemispherical view.

FIG. 5 is a diagrammatic view of a household area with a floor mounted fish eye or panoramic camera for photographing household items, with the capability to extend upwardly from the floor of the household room or area and produce a single or segmented 360 degree, panoramic or hemispherical view.

FIG. 6 is a diagrammatic view of a household area with a floor mounted fish eye or panoramic camera for photographing household items, with the capability to extend upwardly from the floor of the household room or area and produce a single or segmented 360 degree, panoramic or hemispherical view.

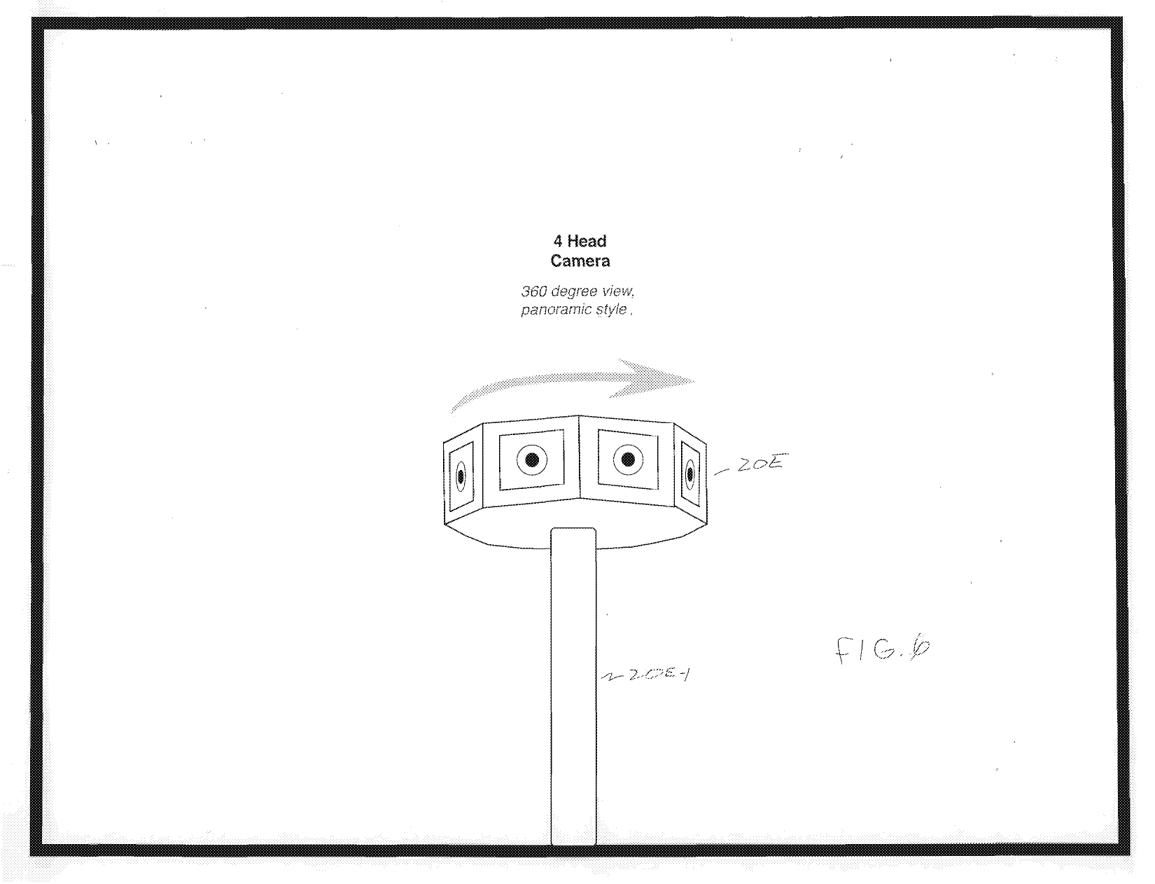

FIG. 7 is a flow diagram illustrating an exemplary embodiment of a data collection method utilizing a camera system as illustrated in any of FIGS. 1-5.

### DETAILED DESCRIPTION

In the following detailed description and in the several figures of the drawing, like elements are identified with like reference numerals. The figures are not to scale, and relative feature sizes may be exaggerated for illustrative purposes.

The subject system and method, called for purposes of this application the ‘Fettered Nest,’ is one that can be installed in any size domicile either with initial or retrofit construction. A function of the system and method is the automated compilation of an accurate, irrefutable household item inventory.

Google's Street View system is familiar to Internet users, for providing a user-maneuverable streetscape. In one exemplary embodiment, the present system interfaces with users and may have some similarities in appearance to the Street View system. But rather than the subject matter being a streetscape, it is the interior-scape of people's homes, with back end recording, item identification and inventorying software.

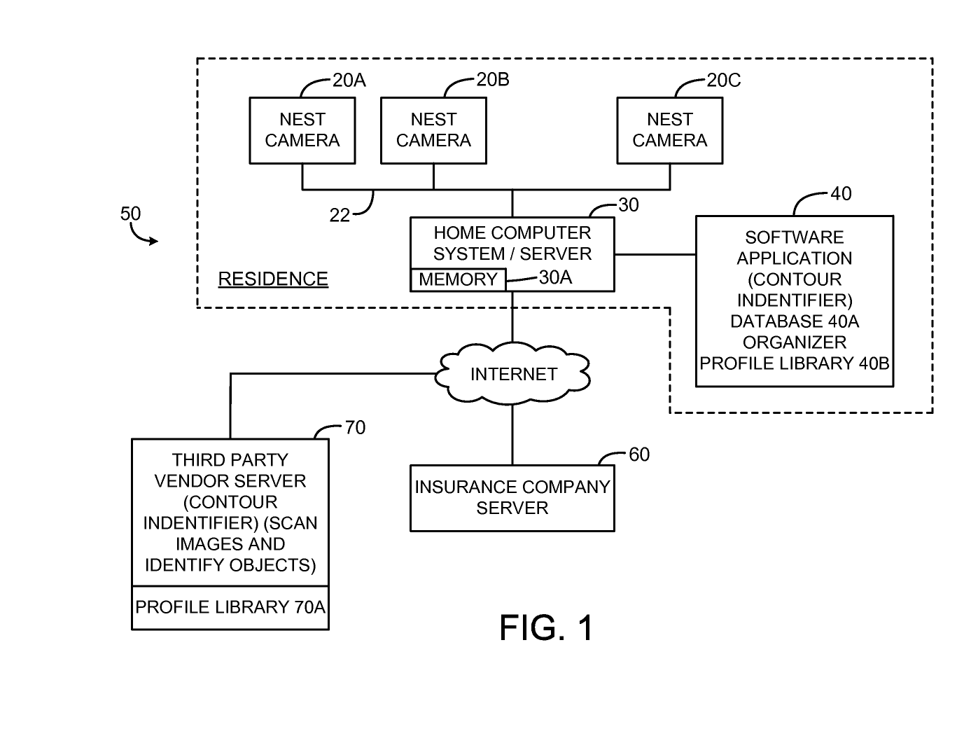

A simplified block diagram of an exemplary embodiment of a system 50 is depicted in FIG. 1. This exemplary embodiment of a household-wide system includes one or more camera units 20A, 20B, 20C . . . , arranged in the residence so as to provide coverage of the household area desired to be monitored or inventoried. This might be one camera unit per room, for example, or more depending on the room size and layout. The camera units may be small, unobtrusive ceiling mounted camera units, perhaps similar to the video surveillance orbs utilized in casinos and other commercial applications, with built-in 360 degree field of vision, e.g. using a specialized lens. The 360 degree field of vision may also be achieved by a fixed lens camera, mounted on a motorized and computer controlled rotating base, capturing overlapping images which are then interlaced. Each camera unit, whether still or video, has a unique identifier, so that the house-wide system could be surveyed sequentially, the images interlaced and the contents of the entire domicile tracked accordingly.

The camera units may be either hard-wired into a home computer-based computer or server system 30, or may wirelessly transmit their collected data over Bluetooth or Wi-Fi links or networks 22 to the system 30 for processing. The camera units may be attached to the ceiling or wall by anything from a special, motorized rotating camera mount to a fixed wiring harness bracket to simple peel-and-stick adhesive for compact, self-contained Wi-Fi enabled (or cellular-enabled) units.

To be sure, camera systems much like that described here exist, for example the D-Link DCS 6010L Wireless N 360° Home Network Camera Network with fixed dome. But those systems were created, are programmed for and are marketed for home security applications. Applicant has identified mechanical performance enhancements and expanded software-enabled applications that would bring new, novel and needed utilities, which, in one exemplary application will benefit the homeowner, insurance industry and their customers.

Still referring to FIG. 1, the home computer system 30 includes a memory 30A, and is configured to run a software application designed to activate or control the camera units to collect images of the surveilled scenes, process the images using, for example, contour identifier algorithms to discern the specific objects in the images, and set up and maintain a database of the objects within the residence.

In accordance with a further aspect, the computer system 30 may be connected to the Internet, and the application 40 configured to communicate with the homeowner's insurance company server or website 60 to provide an electronic file of the object inventory for the homeowner. The computer system 30 may also be configured to communicate through the Internet with a third party vendor server 70, which is configured to receive some or all the homeowner object images to utilize the vendor's application software to identify some or all images in the residence. This may be an alternative configuration to the application software 40 running on the computer system 30, or in addition to the application 40, e.g. to provide a further way to identify objects not identified by application 40.

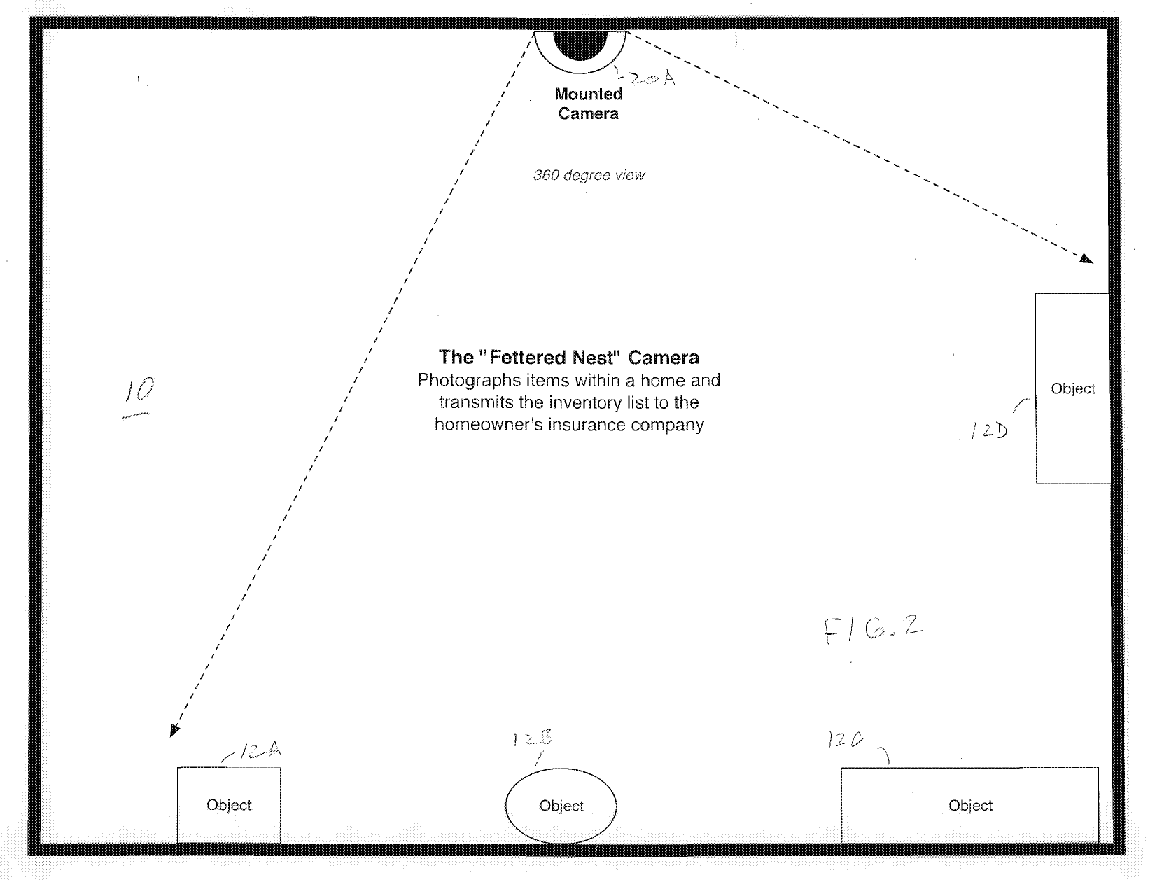

FIG. 2 diagrammatically illustrates an exemplary installation of a camera unit 20A in a room 10 or other space, depicting the camera unit as being mounted to the room ceiling or wall, and configured to have several objects in the room, such as objects 12A, 12B, 12C and 12D, within the camera unit's field of view. Preferably for a ceiling mounted camera unit, it has a 360 degree field of view. The objects may be a table 12A, a television set 12B, a bookcase 12C and a wall mounted cabinet 12D, by way of example.

To facilitate the cameras' wide field of vision, the camera unit mounts could include servo-controlled rotational devices, which could be automatically oriented by the recording software on areas whose contents are identified as missing from the inventory after an initial scan.

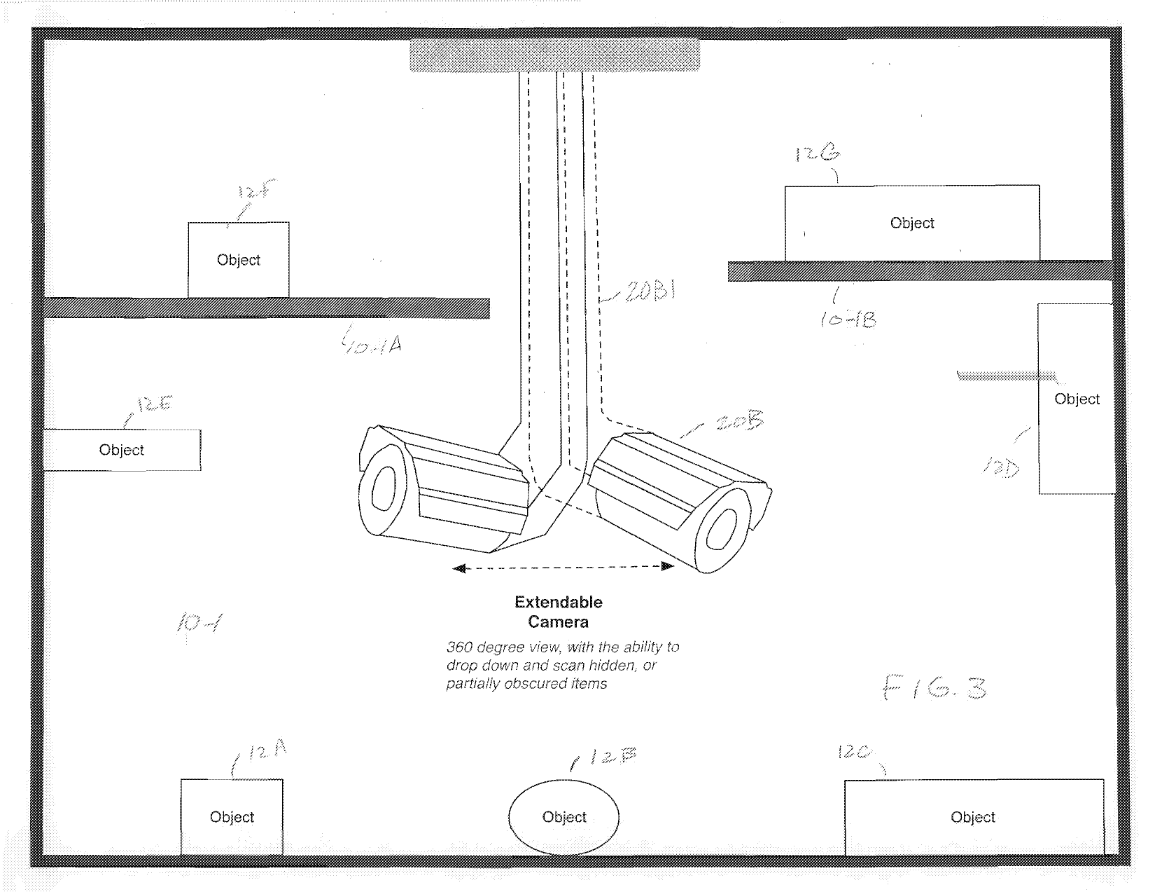

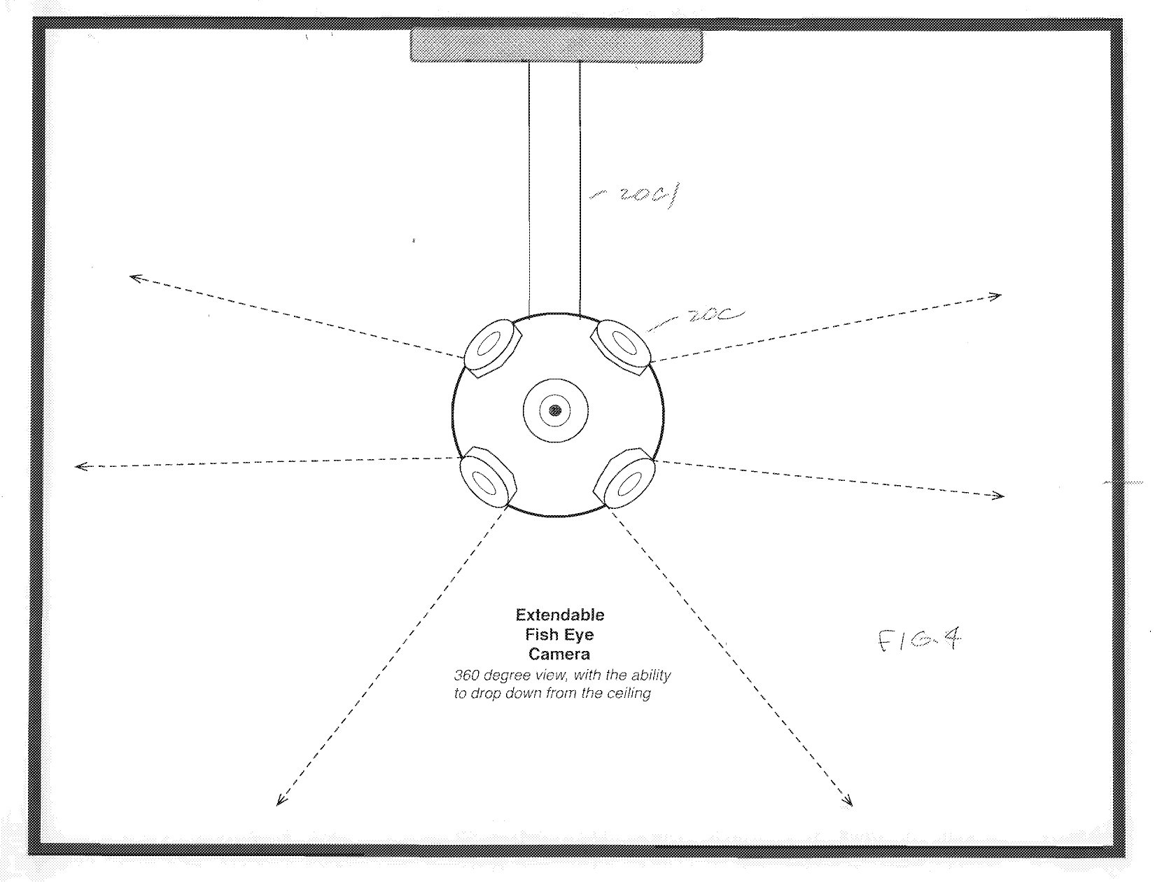

To accommodate situations where light fixtures, shelves, exposed beams or soffits or other objects block the field of view, the camera unit may be attached to a telescoping arm or suspended from retractable or servo-controlled wires, which could be merely for suspension or serve data transmission functions as well. FIG. 3 illustrates a room space 10-1, in which objects 12F and 12G are positioned on shelves 10-1A and 10-1B respectively. The camera unit 20B is ceiling mounted, by a motorized telescoping mount 20B1, configured to extend the camera downwardly from the ceiling and rotate the camera unit. This allows the camera unit to bring not only objects on the shelves 10-1A and 10-1B into camera view, but also objects 12D and 12E mounted on walls below the shelves as well. FIG. 4 shows an extendable fish eye camera unit 20C, ceiling mounted by mount 20C-1 which is configured to extend the camera unit downwardly from the ceiling. With the camera unit having a field of view that may be 360 degrees, the mount 20C-1 may not include a rotational capability.

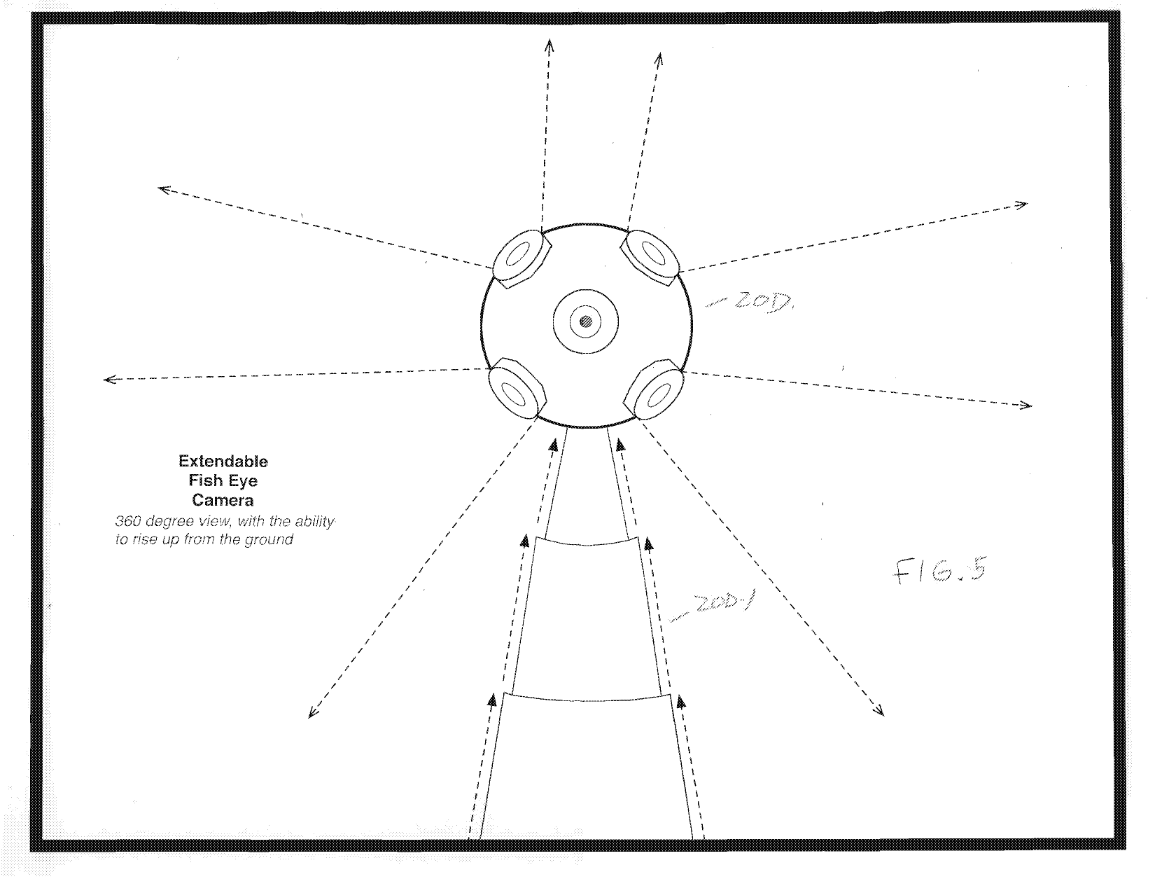

In another embodiment illustrated in FIG. 5, the system could include a single, floor-based portable mounted camera stand 20D-1 for a camera unit 20D, that would be manually positioned and triggered in the center of each living area. Schematics generated by the software application 40 could inform the homeowner where to position the unit and alert him to correct it if not accurate. With advances in robotic technology, these freestanding mobile units could be remotely and/or system-guided to position themselves where needed for optimal field of vision. In an alternative to a 360 degree camera unit, a multiple head camera head unit 20E may be employed, with perhaps four camera lenses spaced about the head, and rotatable by mount 20E-1 to provide 360 degree coverage. A similar multiple head camera unit may also be employed in a ceiling mounted application.

As increased demand and manufacturing efficiencies bring the price of the cameras and other components down, and enhanced miniaturization techniques can economically be employed, the ceiling mounted camera units could also be incorporated into double-duty units such as smoke and/or carbon dioxide detectors. In point of fact, the $39.00 Dot 360 degree camera from Kogeto (www.kogeto.com) for iPhone 5s/5/4s which comes with Kogeto's free Looker app may be adequately compact and economical to allow for this integration, and even suitable for use as the primary camera units within the system. In these multi-function applications, the Fettered Nest System described herein can enhance the primary functionality of the detector (smoke, carbon monoxide, motion detection) components to the benefit of the insurance industry. That is because their built in communication capability would allow the detector unit to transmit alerts throughout a multi-unit housing structure, for example, as well as to alert fire departments once certain criteria such as duration, intensity and/or temperature of the event, has been reached.

An independent cell phone app can alternatively be employed to obtain the images of the household space. One such app is the “Cycloramic” iPhone app, available on the Apple iTunes site, which runs on an Apple iPhone 5 cell phone. The cell phone is balanced upright on a flat surface, and the app causes the phone vibrator to vibrate at frequencies that cause the cell phone to rotate on the surface while recording video. The resultant video or images are stitched or interlaced together, and could be subjected to contour identification, as described more fully below.

In one exemplary embodiment, at predetermined intervals or when triggered manually, either at the computer server 20 or through a remote control unit or a smart phone app, the cameras in the system are activated to capture images of the contents of each room. These images are transmitted to the server system 30 and linked through software application 40 so that they could be interlaced, (i.e. producing individual images which overlap each other so overlapping elements in the POV (point of view) can be identified and the ‘total picture’ is pieced together—much like NASA does with photos of the planets and galaxy) and their contents interpreted with each individual item that is encountered identified, inventoried and automatically entered into a spreadsheet log. For inordinately large or irregularly shaped rooms, additional camera units would be utilized. Image recognition or contour identification applications exist today, and may be adapted to this application. One such example is the Amazon “Flow” application, which recognizes a product through the cell camera image. Other vendors and applications may alternatively be employed.

The image data may be fed to ‘Contour Identifier’ image recognition software application 40, which may consult a massive fixture profile database library 40B. The database library entries may, for example, be gleaned from online retail site postings, or entered manually by a database custodian. Item size may be automatically determined by the computer application 30 through comparison to the fixed dimensions of the room or other metrics. The system may then list both known and unknown items in a home inventory spreadsheet database 40A, with as much specificity as possible: for example: 47 inch Sony TV, 6 Queen Anne chairs, a 36″×72″ mahogany wood table with 2 leaves, a Black & Decker Model 1234 Toaster Oven. Where possible the system may provide estimated value or average retail purchase prices, if available. With further database development, the system may be able to identify potentially valuable, but overlooked works of art or antiques, and alert the homeowner's attention to them so he or she can investigate further. The software application may run on the homeowner's computer 30, e.g. a pc, Mac or other computer, or alternatively on a remote server 70 connected through the Internet.

The homeowner may then go into the local database 40A and, for example at the software application 40 specific prompting, manually label unidentified items. Automatic software processing may ‘flatten’ the 360 degree view into familiar two dimension imagery to facilitate review. The user may also manually enter additional identifiers such as a serial number and/or manufacturer, or item age. The latter may also be verified by auto-comparison to earlier photo survey scans and marked as such. When the homeowner detects specific items or details missing from the inventory, he can manually enter their information and/or upload additional photos for incorporation into the database.

An additional iterative feature that may be built into the system is the option to upload photos of item serial numbers and packaging bar codes, and interpret and translate through internet searches what they represent for incorporation into the spreadsheet. It may also provide a convenient location within the room where the system's camera can visually record and integrate this identifying information on demand.

Prior to initiating the scanning sequence to capture images within the residence for inventory analysis, the system 50 may alert the homeowner of the scheduled scan either through email, text and/or other means including an on-site audible alert and/or flashing light. This would give the homeowner adequate time to prepare the room and/or premises by, for example, cleaning up messes, positioning items properly, protecting privacy, etc. In another exemplary embodiment, the scanning will not begin without being manually triggered by the homeowner when ready. If an alert is initiated and too much delay (24-36 hours, for example) elapses before the performance of the scan, both the homeowner and insurance carrier may be notified automatically for rescheduling of the scan.

When the system encounters blocked views, such as closed cabinets, drawers and closed doors (closet or otherwise) it may prompt the homeowner via electronic message or audible alert to open these obstructions (sequentially in the case of drawers) so that sub-scans of the contents might be captured, and the interrelationship of one room to the next could be established.

While specific items might remain unidentified for various reasons, including for example because of their orientation to the camera's field of view, the continuous (i.e. repeated and updated over time) photo inventory of household goods that could be maintained for insurance purposes will provide far better benchmarks than are currently available. The picture data may be stored locally on the home server for inventory list confirmation and modification by the homeowner. It might also be transmitted to the ‘cloud’ for safe, backup storage.

Finally, upon the homeowner's satisfaction with completion of the inventory, he would submit it to the insurance company for a rating. Based on the value of the contents, they could recommend or require an increase in the coverage limit of established policies. The homeowner, in turn, could submit the same inventory to a variety of carriers for competitive quotes.

Initial scans and inventories would, by necessity, be more labor intensive than periodic update scans. But long-term the overall level of computer assistance and its accuracy would make the Fettered Nest system desirable to homeowners and insurers alike.

The system could also function as a security monitor system, either triggered when an unidentified moving object moves into its field of vision and/or live and controlled remotely in real time via coupling with a smart device such as a cell phone or tablet. This would allow nanny cam type monitoring of residents and their activities. Automatic software processing could ‘flatten’ the 360 degree view into familiar 2D.

The system would financially benefit consumers and perhaps pay for itself through the enhanced competition between carriers and the easier ability to compare policies. The system may be subsidized through insurance premium discounts. At the homeowners' option, and to perhaps offset the hardware and installation expense, the information gleaned of item ownership might be made available to marketers.

In another iteration the entire household inventory process could be based on smartphone capabilities. The app would be downloaded onto a mobile phone device. A graphical user interface would allow the establishment and scheduling of the inventorying sessions. Reminders could be texted by the system or an automated voice call system could be utilized, as well as directly through the reminder function resident in most smartphones. The panoramic camera could be affixed to the phone, but other focal plane lens capabilities could be used as well, and could also be applied to resident moving video capabilities.

While conducting the photo inventory, sound or voice commands sent through the phone could direct the user to “move higher, to the left, move in” etc. while the software records the visual field and/or syncs new visual data with information in the established database. Voice directions could also call the users attention to items seen, but not sufficiently identified, so that closer, multi-angled views can be captured until the item has been identified. This would be facilitated by the compact size of the phone.

The visual field being recorded could be sent wirelessly to the private database for processing and preservation or, resident processing capabilities allowing, could be preserved and locked on the actual phone until shared with the insurance carrier, so there are less invasion of privacy concerns.

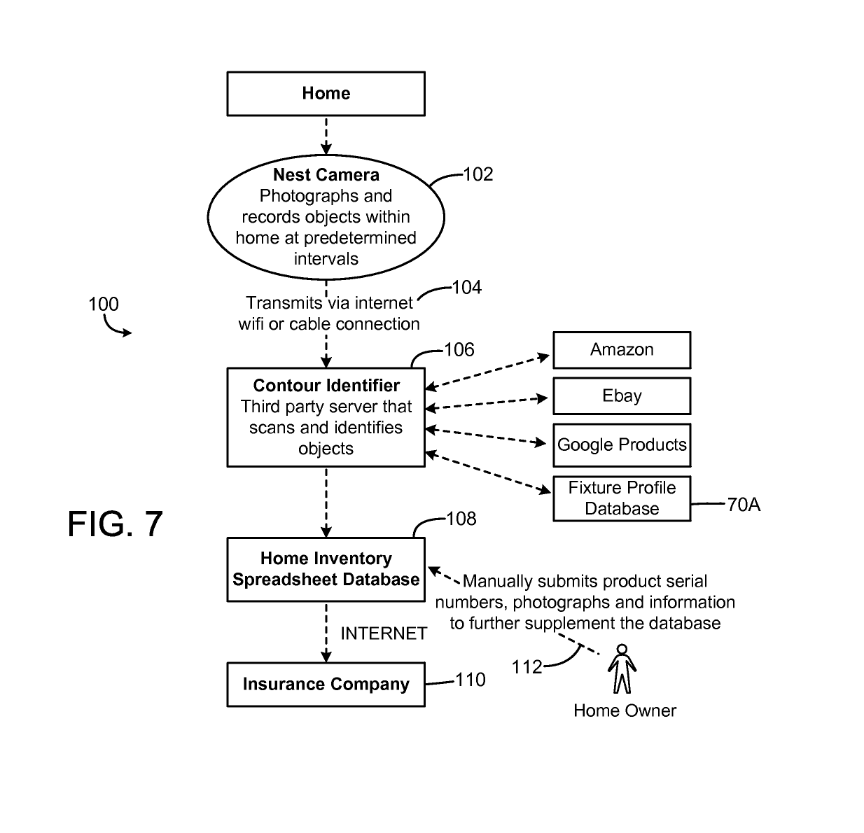

FIG. 7 diagrammatically illustrates an exemplary embodiment of a process 100 for establishing an inventory database. At 102, the camera unit(s) photograph and record images of objects within the home at predetermined intervals, or as manually triggered by the homeowner. The images are transmitted (104) via Internet, Wi-Fi, or other wireless or cable connection to the home computer system 30. In this example, the computer system software application is configured to send the image data to a third party vendor server 70 (FIG. 1) with a contour identifier application that scans the image and identifies the objects shown in the images. The contour identifier application can consult external sales sources such as Amazon, eBay, Google Products, or the like, in the process of identifying the objects and providing detailed information such as cost/value. A spreadsheet database 70A is established (108) with a listing of the objects identified in the images, either by the third party vendor, or by the computer system 30 based on the results provided by the third party server. The homeowner can supplement the database by manually entering or submitting product descriptions, photographs, serial numbers and other data. The database can be sent electronically through an Internet connection to the homeowner's insurance company, for use in establishing coverage, determining policy limits, processing loss claims and the like.

Although the foregoing has been a description and illustration of specific embodiments of the invention, various modifications and changes thereto can be made by persons skilled in the art without departing from the scope and spirit of the invention.

What is claimed is:

1. A system for automated preparation of a goods inventory of a residence or business, comprising:
a camera system configured to provide electronic images of the interior of the residence or business and including household or other objects arranged within the residence;
a computer system connected to the camera system by wires or by wireless communication, and arranged to process the images to develop a list of the objects recognized, and to identify any unrecognized objects for manual identification by the homeowner or proprietor.

2. The system of claim 1, wherein the computer system is configured to upload the list to an email, server or website for association with an insurance policy of the homeowner or proprietor.

3. A method for establishing an inventory database of objects, comprising:
photographing and recording images of objects within a home or business at predetermined intervals, or as manually triggered by a homeowner or business operator;
transmitting the images via Internet, Wi-Fi, other wireless or cable connection to a home or business computer system configured with a software application or to send the images to an external server with a contour identifier application that scans the images and identifies the objects shown in the images; and
establishing an inventor database with a listing of the objects identified in the images.

4. The method of claim 3, further comprising:
sending the database electronically through an Internet or mobile connection to an external server or website associated with an insurance provider or underwriter, for use in establishing or maintaining coverage, determining policy limits, or processing loss claims.

5. The method of claim 3, further comprising:
manually supplementing the database with object data.
